(19) United States
(12) Patent Application Publication
(10) Pub. No.: US 2008/0288557 A1
(43) Pub. Date: Nov. 20, 2008

(54) System for backing up and recovering data applied to data processing apparatus and method for the same

(75) Inventor: You-Yu Chiu, Jhonghe City (TW)

Correspondence Address: REED SMITH LLP, Suite 1400, 3110 Fairview Park Drive, Falls Church, VA, 22042, US

(73) Assignee: ICP Electronics Inc.

(21) Appl. No.: 11/826,635

(22) Filed: Jul. 17, 2007

(30) Foreign Application Priority Data
May 16, 2007 (TW) 096117458

(51) Int. Cl. G06F 12/16

(52) U.S. Cl. 707/202; 707/E17.007

(57) ABSTRACT

The invention discloses a data backup/recovery system for backing up and recovering data in a data processing apparatus. The data processing apparatus comprises a Basic Input Output System (BIOS) with a memory, a System Data Security Module (SDSM), and the data backup/recovery system. The SDSM is used for storing a backup data and has a real time clock. The data backup/recovery system determines whether the backup data should be recovered to the BIOS by checking whether the checksum of the memory fails and whether there is a copy of the backup data stored in the SDSM. Finally, the data backup/recovery system backs up the data stored in the memory to the SDSM. Accordingly, the data backup/recovery process is accomplished.

### BACKGROUND OF THE INVENTION

1. Field of the Invention

The invention relates to a data backup/recovery system and method, and more particularly, to a data backup/recovery system and method capable of automatically recovering data to the setting made by the last user when the data stored in the complementary metal oxide semiconductor (CMOS) of the data processing apparatus fails.

2. Description of the Prior Art

The main board of data processing apparatus nowadays provides a basic input output system (BIOS) for controlling the operation of central processing unit (CPU), the operation of every chip and every standard peripheral device. Generally, the BIOS utilizes a CMOS to save system parameters. The user can set the CMOS parameters via BIOS setting procedure. The power for CMOS is supplied by a system power supply or a back-up battery so that the CMOS data would not be lost when power is off. However, when the power of battery is too low or when the checksum fails, the system can not correctly recover the CMOS data back to the setting of the last user, but back to the default setting, and the real time clock (RTC) can not be correctly recovered.

In other words, once the CMOS data is lost, the user must enter the BIOS setting to set the system parameters the next time the system is started. This is very inconvenient for the users.

Therefore, the scope of the invention is to provide a data backup/recovery system and method applied in the data processing apparatus for solving the above-mentioned problems.

### SUMMARY OF THE INVENTION

A scope of the invention is to provide a data backup/recovery system and method for backing up the system data to a system data security module (SDSM). Once the system data fails, the data backup/recovery system can recover the data to the setting made by the last user.

Another scope of the invention is to provide a data backup/recovery system and method with a real time clock (RTC) installed in the SDSM. Once the data system fails, the data backup/recovery system recovers the correct system time according to the RTC.

According to an embodiment, the data backup/recovery system and method of the invention is for backing up and recovering the data in a data processing apparatus. The data processing apparatus consists of both a BIOS and a SDSM. The BIOS has a memory. The backup/recovery system comprises a first processing unit, a second processing unit, a third processing unit, a fourth processing unit, a fifth processing unit, a sixth processing unit, and a seventh processing unit.

In this embodiment, the first processing unit checks whether the checksum of the memory fails when the data processing apparatus is powered on. Once the checksum fails, the second processing unit checks whether a copy of the backup data has been stored in the SDSM. If it is detected that the SDSM has a copy of the backup data, the third processing unit recovers the backup data to the memory of the BIOS. The fourth processing unit is for selectively changing the setting of the BIOS and then saving the new setting of the BIOS to the memory. The fifth processing unit is for backing up the data saved in the memory to the SDSM.

Besides, the SDSM has a RTC and a battery for supplying power to the RTC. According to the RTC, the sixth processing unit can update the RTC of the memory (i.e., system time) with the RTC of the SDSM.

In this embodiment, the memory of the BIOS can be a CMOS memory. The SDSM comprises a non-volatile memory, such as an electrically erasable programmable read-only memory (EEPROM), for storing the backup data.

Therefore, according the data backup/recovery system and method of the invention, once the system data stored in the memory of the BIOS is lost, the data processing apparatus can automatically recover the copy of the backup data stored in the SDSM to the memory of the BIOS at the next start. Furthermore, the data processing apparatus can also automatically recover the system time according to the RTC in the SDSM.

The advantage and spirit of the invention may be understood by the following recitations together with the appended drawings.

### BRIEF DESCRIPTION OF THE APPENDED DRAWINGS

FIG. 1 is a functional block diagram illustrating a data processing apparatus according to a preferred embodiment of the invention.

FIG. 2 is a flow chart illustrating a data backup/recovery method according to a preferred embodiment of the invention.

### DETAILED DESCRIPTION OF THE INVENTION

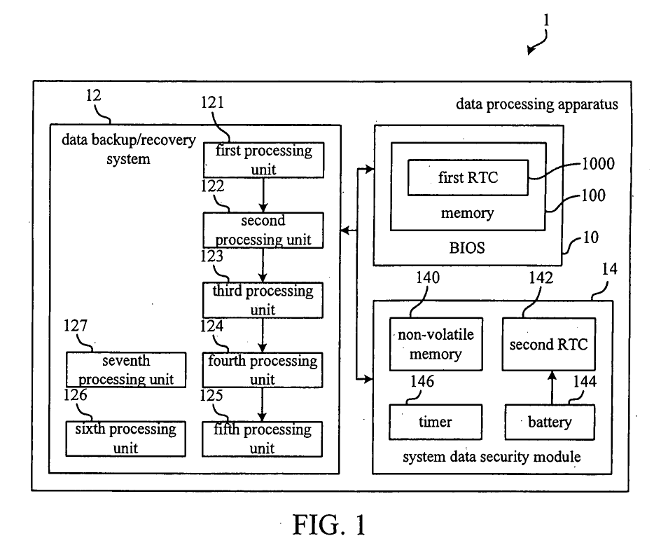

Please refer to FIG. 1. FIG. 1 is a functional block diagram illustrating a data processing apparatus 1 according to a preferred embodiment of the invention. The data processing apparatus 1 comprises a basic input output system (BIOS) 10, a data backup/recovery system 12, and a system data security module (SDSM) 14. The data processing apparatus 1 can be a personal computer or other electric devices. The central processing unit (not shown) of the data processing apparatus 1 can communicate with the SDSM 14 via a system management bus (SMBus), a low pin count (LPC) interface, or other similar interfaces.

The BIOS 10 comprises a memory 100 and a first real time clock (RTC) 1000, wherein, the memory 100 can be a CMOS memory or other similar memories.

The data backup/recovery system 12 comprises a first processing unit 121, the second processing unit 122, the third processing unit 123, the fourth processing unit 124, the fifth processing unit 125, the sixth processing unit 126, and the seventh processing unit 127.

The SDSM 14 comprises a non-volatile memory 140, a second RTC 142, a battery 144, and a timer 146. The non-volatile memory 140 can be an electrically erasable programmable read-only memory (EEPROM) or other similar memories. The battery 144 is for supplying power to the second RTC 142.

In this embodiment, when the data processing apparatus 1 is powered on, the first processing unit 121 checks whether the checksum of the memory 100 fails. If the checksum fails, the second processing unit 122 checks whether a copy of backup data has been stored in the SDSM 14. If it is detected that the SDSM14 has a copy of the backup data, the third processing unit 123 recovers the backup data to the memory 100. The fourth processing unit 124 can selectively change the setting of the BIOS 10 according to the operation of the user and then saves the new setting of the BIOS 10 to the memory 100. The fifth processing unit 125 is for backing up the data saved in the memory 100 to the non-volatile memory 140 of the SDSM 14.

In practical application, the non-volatile memory 140 of the SDSM 14 can also be used for storing system parameters of the data processing apparatus 1, such as the temperature of the central processing unit (not shown), the temperature of the system, the rotational speed of the fan, and/or other system parameters.

From what was mentioned above, once the system data stored in the memory 100 is lost, the data backup/recovery system 12 automatically recovers the copy of the backup data stored in the SDSM 14 to the memory 100, so that the user does not need to set up the system data again. Furthermore, every time the user changes the setting of the BIOS 10, the data backup/recovery system 12 automatically updates the copy of the backup data in the SDSM 14. Accordingly, once the system data fails, the data backup/recovery system 12 can automatically recover the data to the setting of the last user.

As shown in FIG. 1, the memory 100 comprises a first RTC 1000, and the SDSM 14 comprises a second RTC 142. The sixth processing unit 126 of the data backup/recovery system 12 is for reading the second RTC 142 from the SDSM 14, and then updating the first RTC 1000 of the memory 100 according to the second RTC 142. In other words, once the system data is lost, the data backup/recovery system 12 can automatically recover the system time according to the second RTC 142 of the SDSM 14.

Besides, the SDSM 14 can comprise a timer 146. In this embodiment, the seventh processing unit 127 of the data backup/recovery system 12 drives the timer 146 to count when the data processing apparatus 1 is powered on. The data backup/recovery system 12 drives the BIOS 10 to read the second RTC 142 from the SDSM 14 at predetermined time with regular intervals and then updates the first RTC 1000 of the memory 100 according to the second RTC 142. Accordingly, the accuracy of the system time of the data processing apparatus 1 can be further ensured.

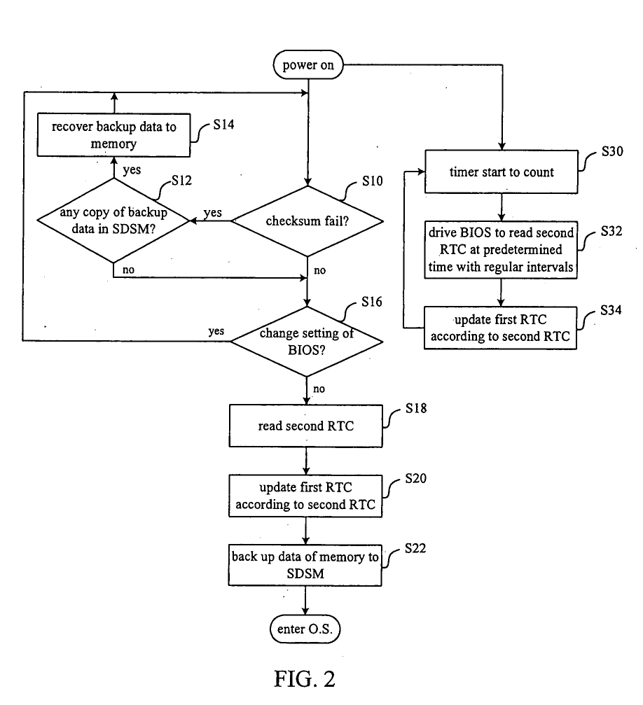

Please refer to FIG. 2 along with FIG. 1. FIG. 2 is a flow chart illustrating a data backup/recovery method according to a preferred embodiment of the invention. The data backup/recovery method of the invention comprises the following steps.

First, when the data processing apparatus 1 starts, step S10 is executed to check whether a checksum of the memory 100 fails. If yes, step S12 is executed; if no, step 16 is executed.

At step S12, it is checked whether a copy of the backup data has been stored in the SDSM 14. If yes, step S14 is executed; if no, step S16 is executed.

At step S14, the backup data is recovered to the memory 100 and then the steps go back to step S10.

At step S16, the user selectively changes the setting of the BIOS 10 for operational purposes. If the user changes the setting of the BIOS 10, the new setting of BIOS 10 is saved in the memory 100 and the procedure goes back to step S10; if the user does not change the setting of the BIOS 10, step S18 is executed.

At step S18, the second RTC 142 is read from the SDSM 14.

Afterwards, step S20 is executed to update the first RTC 1000 of the memory 100 according to the second RTC 142.

Lastly, step S22 is executed to backup the data saved in the memory 100 to the SDSM 14.

Furthermore, according to the above-mentioned embodiment, the data backup/recovery method can provide a function for adjusting the first RTC 1000 of the memory 100 at predetermined time with regular intervals, and the function comprises the following steps.

First, when the data processing apparatus 1 is powered on, step S30 is executed to drive the timer 146 to count. Afterwards, step S32 is executed to drive the BIOS to read the second RTC 142 from the SDSM 14 at predetermined time with regular intervals. Lastly, step S34 is executed to update the first RTC 1000 of the memory 142 according to the second RTC 142.

Compared to the prior art, according to the data backup/recovery system and method of the invention, once the system data saved in the memory of the BIOS is lost, the data processing apparatus can automatically recover the copy of the backup data stored in the SDSM to the memory of the BIOS the next time the system is powered on. Additionally, the data processing apparatus can automatically recover the system time according to the RTC of the SDSM. It is very convenient for the users.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data backup/recovery system for backing up and recovering data in a data processing apparatus consisting of both a basic input-output system (BIOS) having a memory and a system data security module (SDSM) having a timer, in which the memory of the BIOS consists of a first real time clock (RTC), the data backup/recovery system comprising:
a first processing unit for checking whether a checksum of the memory in the BIOS fails;
a second processing unit for checking whether a copy of the backup data has been stored in the SDSM once the checksum fails;
a third processing unit for recovering the backup data to the memory when it is detected that the SDSM has a copy of the backup data;
a fourth processing unit for selectively changing the setting of the BIOS and then saving the new setting of the BIOS to the memory; and
a fifth processing unit for backing up the data saved in the memory to the SDSM.

2. The data backup/recovery system of claim 1, further comprising a sixth processing unit for reading a second RTC from the SDSM and then updating the first RTC of the memory according to the second RTC.

3. The data backup/recovery system of claim 2, further comprising a seventh processing unit for driving the timer of the SDSM to count when the data processing apparatus is powered on, and then the data backup/recovery system driving the BIOS to read the second RTC from the SDSM at predetermined time with regular intervals and then updating the first RTC of the memory according to the second RTC.

4. A data backup/recovery method for backing up and recovering data in a data processing apparatus consisting of both a basic input-output system (BIOS) having a memory and a system data security module (SDSM) having a timer, in which the memory of the BIOS consists of a first real time clock (RTC), the method comprising steps of:
(a) checking whether a checksum of the memory in the BIOS fails, if yes, executing step (b), if no, executing step (d);
(b) checking whether a backup copy of data has been stored in the SDSM, if yes, executing step (c), if no, executing step (d);
(c) recovering the backup data to the memory and then going back to step (a);
(d) selectively changing the setting of the BIOS and then saving the new setting of the BIOS to the memory; and
(e) backing up the data saved in the memory to the SDSM.

5. The method of claim 4, wherein step (d) further comprises steps of:
reading a second RTC from the SDSM; and
updating the first RTC of the memory according to the second RTC.

6. The method of claim 5, further comprising steps of:
driving the timer of the SDSM to count time when the data processing apparatus is powered on;
driving the BIOS to read the second RTC from the SDSM at predetermined time with regular intervals; and
updating the first RTC of the memory according to the second RTC.

7. A data processing apparatus comprising:
a basic input output system (BIOS) having a memory;
a system data security module (SDSM);
a data backup/recovery system comprising:
a first processing unit for checking whether a checksum of the memory fails;
a second processing unit for checking whether a copy of the backup data has been stored in the SDSM when the checksum fails;
a third processing unit for recovering the backup data to the memory when it is detected that the SDSM has a copy of the backup data;
a fourth processing unit for selectively changing the setting of the BIOS and then saving the new setting of the BIOS to the memory; and
a fifth processing unit for backing up the data saved in the memory to the SDSM.

8. The data processing apparatus of claim 7, wherein the memory comprises a first RTC and the SDSM comprises a second RTC.

9. The data processing apparatus of claim 8, wherein the data backup/recovery system further comprises a sixth processing unit for reading the second RTC from the SDSM and then updating the first RTC of the memory according to the second RTC.

10. The data processing apparatus of claim 8, wherein the SDSM comprises a timer.

11. The data processing apparatus of claim 10, wherein the data backup/recovery system further comprises a seventh processing unit for driving the timer of the SDSM to count when the data processing apparatus is powered on, and then the data backup/recovery system drives the BIOS to read the second RTC from the SDSM at predetermined time with regular intervals and updates the first RTC of the memory according to the second RTC.

12. The data processing apparatus of claim 8, wherein the SDSM comprises a battery for supplying power to the second RTC.

13. The data processing apparatus of claim 7, wherein the memory is a complementary metal oxide semiconductor (CMOS).

14. The data processing apparatus of claim 7, wherein the SDSM comprises a non-volatile memory for storing the backup data.

15. The data processing apparatus of claim 14, wherein the non-volatile memory is an electrically erasable programmable read-only memory (EEPROM).

16. The data processing apparatus of claim 7, wherein the SDSM communicates with a central processing unit (CPU) via a system management bus (SMBus) and/or a low pin count (LPC) interface.
